(19) United States
(12) Patent Application Publication
(10) Pub. No.: US 2006/0001828 A1
(43) Pub. Date: Jan. 5, 2006

(54) Automatic identification symbology suitable for contact lens manufacturing verification

(76) Inventors: Robert Duggan, Co. Kilkenny (IE); Gerald J. Frumusa, Rochester, NY (US)

Correspondence Address: Bausch & Lomb Incorporated, One Bausch & Lomb Place, Rochester, NY, 14604-2701, US

(21) Appl. No.: 10/881,356

(22) Filed: Jun. 30, 2004

(51) Int. Cl. G02C 7/04

(52) U.S. Cl. 351/160 R

(57) ABSTRACT

A method of identifying one or more characteristics of an ophthalmic lens by embedding a second marking inside the perimeter of a first marking formed on the lens. In one embodiment, the first marking may be a toric marking indicative of the ballast and/or cylindrical axis and the second marking, placed inside the first marking, may indicate one or more other lens characteristic such as power, SKU or lot number, for example. The invention includes a lens made according to the method.

### BACKGROUND OF THE INVENTION

The present invention relates to a method for identifying characteristics of an ophthalmic lens such as an intraocular lens or contact lens, and lenses made according to the method.

One type of contact lens is commonly referred to as a “spherical contact lens”, i.e., contact lenses designed to provide a spherical optical correction (or “power”) to compensate for myopia (nearsightedness) or hypermetropia (farsightedness). Such contact lenses are also designed with fitting parameters, especially lens diameter and effective base curve. Accordingly, a prescription for spherical contact lenses will typically specify a spherical correction (power), lens diameter and base curve. Using hydrogel lenses as an example, manufacturers typically market a series of spherical hydrogel contact lenses, each series including lenses having common fitting parameters and offering powers in 0.25 or 0.50 diopter increments.

In addition to spherical lenses, there are contact lenses commonly referred to as “toric contact lenses”, i.e., contact lenses having a toric optical zone that are designed to correct refractive abnormalities of the eye associated with astigmatism. The toric optical zone provides cylindrical correction to compensate for the astigmatism, with the cylindrical correction commonly referred to as the “cylindrical power”. The toric surface may be formed in either the posterior lens surface (back surface toric lens) or the anterior lens surface (front surface toric lens). Whereas spherical contact lenses are symmetrical and may therefore freely rotate on the eye, toric contact lenses are asymmetrical and the toric surface must align with the astigmatism of the eye. Therefore, toric contact lenses have ballast or other feature to prevent rotation of the lens on the eye. For example, one or more sections of the lens periphery may be thicker or thinner than other sections to provide the ballast. Toric contact lenses are manufactured with a selected relationship (or offset) between the cylindrical axis of the toric optical zone and the orientation of the ballast. This relationship is expressed as the number of degrees (or rotational angle) that the cylindrical axis is offset from the orientation axis of the ballast; toric contact lens prescriptions specify this offset, with toric lenses generally being offered in 5 or 10 degree increments ranging from 0 to 180 degrees.

Since astigmatism requiring vision correction is usually associated with other refractive abnormalities, such as nearsightedness or farsightedness, toric contact lenses are generally prescribed, in addition to cylindrical power and axes offset, with a spherical correction and fitting parameters as for the aforementioned spherical contact lenses. Accordingly, a prescription for toric contact lenses will typically specify spherical correction (power), lens diameter, base curve, cylindrical correction, and axes offset.

The placing of markings on contact lenses which indicate certain parameters of the lens is generally known. See, for example, U.S. Pat. No. 6,079,826 to Bausch & Lomb Incorporated, assignee herein, which discloses placing markings on the anterior and posterior surfaces of the lens which, in combination, indicate the spherical correction for that lens. In U.S. Pat. No. 6,491,393, also to Bausch & Lomb Incorporated, markings are placed on a toric contact lens, the markings being arranged in a manner that identifies the offset between the cylindrical axis and ballast axis of the lens. U.S. Pat. No. 4,194,814 discloses contact lenses that include identifying indicia engraved in a lens surface by subjecting the lens to a beam of laser radiation to form depressions in the lens surface. It is mentioned that the indicia may be used to identify manufacturer, material lot, and production run of the lens, or to identify optical characteristics of lenses without actually measuring them.

There is thus disclosed in the prior art various methods for placing identifying markings on contact lens which may be read (e.g., automatically by a reading instrument) to ascertain various parameters of the lens. One drawback of these prior art methods is that a lens may have many markings that clutter the peripheral zone of the lens. See, for example, the lens in FIG. 2 of the '826 patent which includes a total of eight markings (markings 6′ and 7′ consist of two characters each). Furthermore, markings which form depressions in the mold tool (which are ultimately transferred to the lens during the molding of the lens) are difficult to clean which is can lead to increased tool costs. It would therefore be desirable to have a method for marking an ophthalmic lens such as an intraocular or contact lens which minimizes the amount of individual markings having to be placed on the lens while still providing the desired amount of information concerning the lens.

### SUMMARY OF THE INVENTION

The present invention provides a method for marking ophthalmic lenses such as intraocular or contact lenses with identifying indicia that indicates any desired parameter of the lens while minimizing the amount of markings needing to be placed on the lens.

The invention will be described in regard to contact lenses although it is understood that the invention is applicable to other types of ophthalmic lenses such as intraocular lenses. It is envisioned that the invention may be applied to other types of optical lenses as well, such as camera and spectacle lenses, for example.

In a first aspect, the invention provides a method for marking a contact lens with first and second markings wherein the second marking is embedded in the first marking. The first marking may comprise a letter or other symbol, for example, that indicates the power of the lens. The second marking may comprise a bar or data matrix code small enough to embed within the outline of the first marking, the bar or data matrix code indicative of the lot and SKU of the lens, for example.

In a further aspect, the invention provides a method of placing markings on a toric contact lens by embedding an identifying code in the ballast and/or toric surface indicating marks. Thus, while the ballast and toric surface marks are already in place to indicate the rotational offset between these two lens features, the code embedded in these marks may indicate one or more other characteristics of the lens as desired, e.g., power, diameter, base curve, SKU, or lot number.

### BRIEF DESCRIPTION OF THE DRAWING

FIG. 1 is a plan view of an exemplary contact lens in accordance with one embodiment of the present invention; and

FIG. 2 is a plan view of an exemplary contact lens in accordance with another embodiment of the present invention.

### DETAILED DESCRIPTION

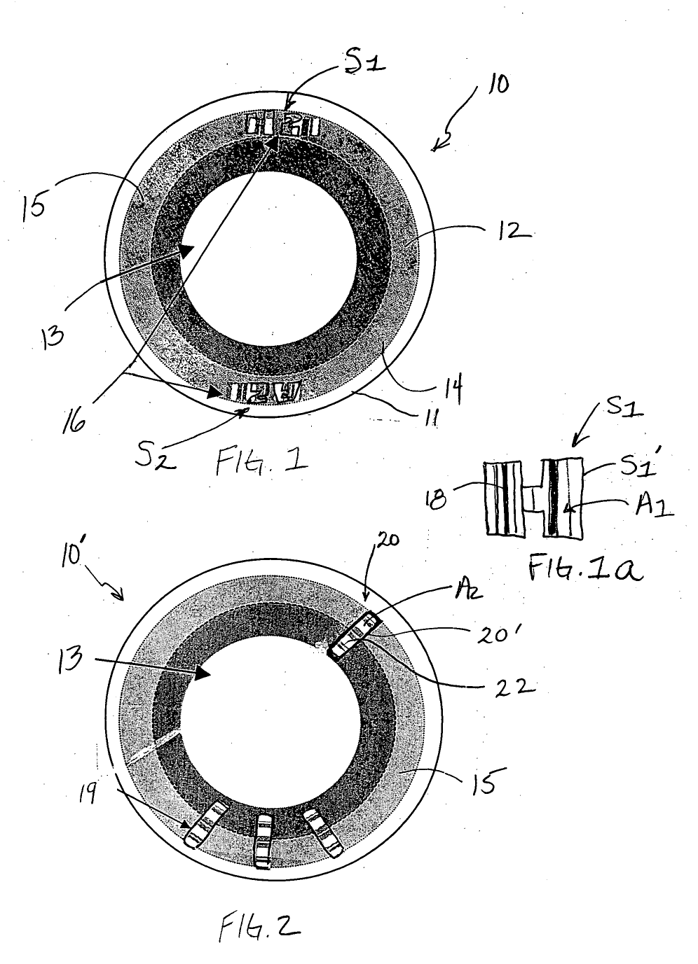

Referring now to the drawing, there is seen in FIG. 1 an exemplary contact lens 10 having an anterior surface 12 and opposing posterior surface 14 surrounded by a peripheral edge 11. At the center of the lens is optical zone 13 surrounded by peripheral zone 15. Lens 10 includes a marking 16 which may consist of one or symbols S1 and S2 located. This marking may indicate any desired property of the lens, e.g., the power of the lens, the manufacturer, an inversion indicator (to tell the wearer which surface goes against the eye), etc.

In the embodiment of FIG. 1, symbols S1 and S2 may be formed on the anterior and posterior tools that make the opposite surfaces of the contact lens as disclosed in the '826 patent to reduce the number of unique tools required to mold a series of lenses. As disclosed in the '826 patent, the symbol may comprise an alphanumeric code, for example. As seen in FIG. 1a, the letter “H” in symbol S1 has a perimeter S1′ and defining an internal area A1. In accordance with a first aspect of the invention, a second marking 18 is formed within area A1. Markings 18 may comprise a bar code as shown in FIG. 1a, or a data matrix code, for example, which indicates one or more other properties of the lens such as lens diameter, base curve, SKU, and lot number, etc. Although it is preferred that the second marking reside completely within the perimeter of the first marking, overlapping may occur where the second marking extends beyond the perimeter of the first marking.

The marking 16 may be applied by any known means, a preferred example being by direct molding into the lens. This is easily accomplished by lathing, etching or otherwise forming the markings in the mold tool used to injection mold the mold halves. The markings in the tools are replicated in the mold halves as raised areas. These raised areas are in turn replicated in the molded lens as recessed areas. Laser etching of the lens may also be used exclusively or in combination with other techniques such as direct molding. For example, the first marking 16 may be directly molded into the lens while the second marking 18 is subsequently laser etched into the lens.

In one possible embodiment of the invention, the first marking may be a toric marking used to identify the cylindrical axis and ballast axis of a toric contact lens. As described above, toric lenses typically include one or more markings along the ballast axis and one or more markings along the cylindrical axis. The angular distance between these markings indicate the rotational offset between the ballast axis and cylindrical axis, commonly referred to as the axis offset. Thus, as seen in FIG. 2, toric lens 10′ includes markings 19 indicative of the ballast axis and marking 20 indicative of the cylindrical axis. One or more of the markings such as marking 20 includes a perimeter 20′ defining an internal area A2 wherein a second marking 22 may be formed. The second marking may indicate one or more lens properties such as power, base curve, diameter, SKU, lot number, etc. The second marking may be a bar code as shown in FIG. 2, or data matrix code, for example, and may be formed on the lens in any desired manner such as those described above.

It will thus be appreciated that the present invention provides a method of marking a contact lens, and a lens formed according to the method, wherein one identifying code may be embedded into another identifying code formed on the lens.

What is claimed is:

1. A method of marking a lens with an identifiable code, said method comprising the steps of:
a) providing a lens;
b) forming a first marking indicative of a first lens characteristic on said lens, said first marking having a perimeter defining an internal area; and
c) forming a second marking indicative of a second lens characteristic on said lens within said internal area.

2. The method of claim 1 wherein said lens is an ophthalmic lens.

3. The method of claim 2 wherein said lens is a contact lens.

4. The method according to claim 1, wherein said second marking is a data matrix code.

5. The method according to claim 2 wherein said contact lens is a toric contact lens having a cylindrical axis and said first marking is indicative of said cylindrical axis of said lens.

6. The method of claim 3 wherein said contact lens has one or more fitting parameters and said second marking is indicative of one or more of said fitting parameters of said lens.

7. The method of claim 3 wherein said contact lens has one or more manufacturing parameters associated therewith and wherein said second marking is indicative of one or more of said manufacturing parameters of said lens.

8. The method of claim 1 wherein said second marking is a bar code.

9. A lens having a first marking having a perimeter and a second marking, said first and second markings indicative of first and second characteristics of said lens, respectively, said second marking being formed within said perimeter of said first marking.

10. The lens of claim 9 wherein said second marking is a data matrix code.

11. The lens of claim 9 wherein said second marking is a bar code.

12. The lens of claim 9 wherein said first marking is indicative of the power of the lens.

13. The lens of claim 10 wherein said lens has one or more fitting parameters associated therewith and said second marking is indicative of one or more of said fitting parameters of said lens.

14. The lens of claim 9 wherein said lens is a contact lens.

15. The lens of claim 9 wherein said lens is an intraocular lens.

16. A contact lens having a first marking having a perimeter and a second marking, said first and second markings indicative of first and second characteristics of said lens, respectively, said second marking being formed within said perimeter of said first marking, one of said first and second markings being a data matrix code.

17. A contact lens having a first marking having a perimeter and a second marking, said first and second markings indicative of first and second characteristics of said lens, respectively, said second marking being formed within said perimeter of said first marking, one of said first and second markings being a bar code.
